(19) United States
(12) Patent Application Publication
(10) Pub. No.: US 2026/0028118 A1
(43) Pub. Date: Jan. 29, 2026

(54) ACTUATOR WITH REDUNDANT CHANNELS

(71) Applicant: Liebherr-Aerospace Lindenberg GmbH, Lindenberg (DE)

(72) Inventors: Thomas IMMLER, Sigmarszell (DE); Frank KRONBURGER, Lindenberg (DE)

(21) Appl. No.: 19/280,729

(22) Filed: Jul. 25, 2025

(30) Foreign Application Priority Data
Jul. 26, 2024 (DE) 10 2024 121 393.0

(51) Int. Cl. B64C 13/50; G05B 9/03; H02K 11/21

(52) U.S. Cl. CPC B64C 13/505; H02K 11/21; G05B 9/03; H02K 2213/06

(57) ABSTRACT

The disclosure relates to an actuator with redundant channels, comprising a motor; a sensor for detecting and transmitting a speed signal from the motor; a first and second channel each having a functional unit connected to the sensor for operating the actuator; a selection unit for selecting whether the first or the second channel controls the actuator, and a motor information unit. Each of the first and second channels supplies a speed information value based on the speed signal to the selection unit. The motor information unit provides a third speed information value of the motor to the selection unit. The selection unit is designed to make a decision on the speed information values as to whether the first channel or the second channel is given control of the actuator.

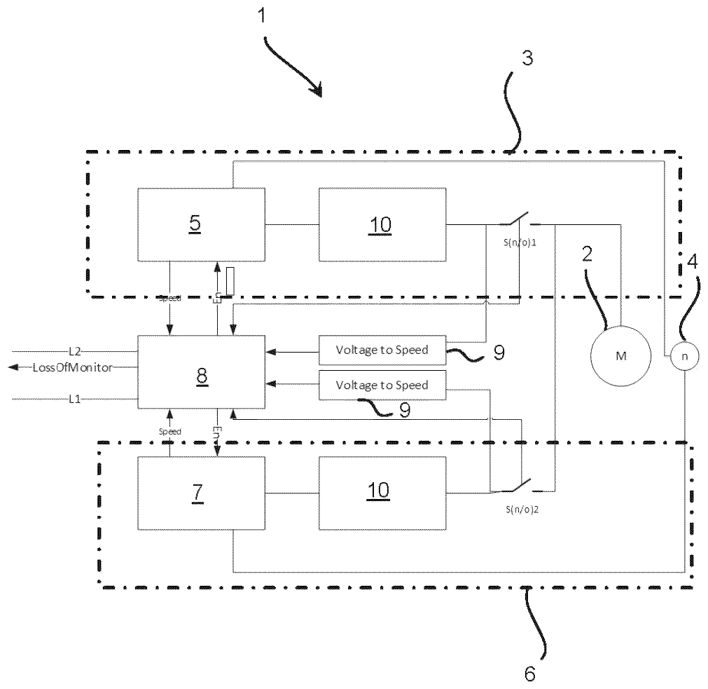

### CROSS REFERENCE TO RELATED APPLICATIONS

The present application claims priority to German Patent Application No. 10 2024 121 393.0 filed on Jul. 26, 2024. The entire contents of the above-listed application are hereby incorporated by reference for all purposes.

### TECHNICAL FIELD

The present disclosure relates to an actuator with redundant channels and to an aircraft with such an actuator.

### BACKGROUND

Actuators are central components in numerous technical systems that carry out mechanical movements using electrical signals. Their reliability and precision are crucial in many applications, in particular in safety-critical areas such as aviation. A known approach to increasing the reliability of actuators is the redundant implementation of important components of the actuator. This technology makes it possible to compensate for failures of individual components and thus maintain the overall functionality of the system even if actuator components fail.

### SUMMARY

Such actuators are of particular importance in aviation. Modern aircraft, including eVTOLs (electric vertical take-off and landing aircraft) and UAVs (unmanned aerial vehicles), benefit significantly from this technology. Redundant actuators ensure that the control and stability of the aircraft is guaranteed even in the event of a fault in one of the redundant signal channels. This is particularly important for flight safety and the reliability of the systems, which have to operate under extreme conditions, and where the failure of an actuator would have a significant impact on the safety and operability of the aircraft.

However, actuators are also used in other areas such as industrial automation, for example in robotics, where they ensure precise and reliable movements of machines and robots, even if individual components fail. Such actuators are also generally indispensable in the automotive sector, in particular in vehicles with autonomous driving capabilities, in order to increase the safety and reliability of vehicle systems.

In order to provide safe actuators and thus implemented control systems according to the prior art, a triplex architecture or a CON/MON architecture (control/monitor architecture) with a higher-level control computer is often used, wherein these implementations known from the prior art are disadvantageous.

In the triplex architecture, for example, there is a control channel that takes over the control, while two other channels monitor the execution. These channels calculate and compare the same objectives in order to determine which of the several channels should be taken into account, i.e. which of the channels is assigned control of the actuator, in the event of deviations using a voting system. The main disadvantage of this architecture is the need to operate three complete and possibly dissimilar channels, which significantly increases costs and complexity.

In the CON/MON architecture with a higher-level control computer, a control channel takes over control, while a monitor channel calculates and monitors the same objectives. The control channel and the monitor channel are redundant to each other and can perform identical objectives. If a discrepancy is detected, a higher-level computer, such as a flight control computer (FCC), is required to decide whether the actuator can continue to be operated or whether another actuator should take over. This architecture has the disadvantage that the control is slow due to the communication between the actuator electronics and the higher-level computer. In addition, the clock frequency of the higher-level computer is usually significantly lower than that of the actuator electronics, so that the higher-level control computer intervenes relatively late, which is disadvantageous in particular in the case of driving or flight manoeuvres influenced by the actuator.

It is the object of the present disclosure to provide an actuator that is improved over the prior art and has a simple yet robust control architecture that can be used specifically for critical applications. The actuator according to the disclosure is intended to overcome or at least mitigate the disadvantages listed above.

This is achieved with an actuator having the features as described herein.

The actuator with redundant channels comprises a motor for actuating the actuator; a sensor, in particular a speed sensor, for detecting and transmitting a speed signal from the motor; a first channel, which has a first functional unit connected to the sensor for operating the actuator; a second channel redundant to the first channel, which has a second functional unit connected to the sensor for operating the actuator; and a selection unit for selecting whether the first channel or the second channel is given control of the actuator, wherein the first channel supplies a first speed information value based on the speed signal to the selection unit and the second channel supplies a second speed information value based on the speed signal to the selection unit. The actuator is characterised by a motor information unit for providing a motor information value, for example a third speed information value of the motor, to the selection unit, wherein the selection unit is designed to make a decision on the basis of the motor information value and the first and second speed information values as to whether the first channel or the second channel is given control of the actuator.

In contrast to the prior art, the present disclosure does not require a higher-level control computer, but instead uses the motor information unit to generate a motor information value so that the selection unit can make a decision as to whether the first channel or the second channel is acting incorrectly based on the first speed information value (generated by the first channel), the second speed information value (generated by the second channel) and the motor information value. Depending on the decision, the channel that is not considered faulty is then used to control the actuator, while the channel that is considered faulty can be isolated from the motor.

A speed sensor or a position sensor of the motor, for example, can be used as a sensor for detecting and transmitting a speed signal from the motor. It is also possible to derive the speed of the motor using a motor position sensor. For the sake of simplicity, the term speed sensor is used in the following, wherein, as explained above, a position sensor of the motor can also be meant here.

This means that no complete third redundant channel is used, but only additional information about the status of the actuator motor is made known to the selection unit. The motor information unit is different to the speed sensor, which provides the basis for the first and second speed information values with its detected speed signal.

This overcomes the typical problem of the CON/MON architecture known from the prior art, which does not know which of the two channels is faulty and which of the two channels provides correct results when a faulty channel is detected. As a result, it is not possible to decide which of the two channels should be used to control the actuator, which means that the entire actuator often has to be deactivated for safety reasons if a fault is detected.

With the present disclosure, it is now possible to compare the first speed information value obtained via the first channel with both the second speed information value and the motor information value, so that a majority decision can then be used to determine whether the first channel or the second channel or the motor information unit is acting incorrectly.

In contrast to triplex architecture, the disclosure does not require a third complete channel, so savings can be achieved in terms of cost and weight.

According to one possible embodiment of the present disclosure, it can be provided that the first functional unit and the second functional unit are each designed to determine the speed information from the speed signal of the speed sensor and/or each comprise a communication unit in order to be able to communicate with a higher-level control unit.

For example, the first and second functional units can each be implemented by a microcontroller or an FPGA in order to calculate a speed signal from the speed sensor signal.

Providing a respective communication unit, which serves to communicate with a higher-level control unit, means it can then be used, for example, to report a fault condition.

According to an optional modification of the present disclosure, it can be provided that the first speed information value and the second speed information value of the motor is a speed of the motor, for example a target speed and/or an actual speed of the motor.

It can also be provided that the motor information value of the motor information unit is a speed of the motor, for example a target speed and/or an actual speed of the motor, or the position of the motor.

If the motor information value is also a speed of the motor, wherein the speed of the motor thus determined is not due to the speed sensor transmitting the speed signal to the first functional unit and the second functional unit, in the event of a fault of the first channel or the second channel, the selection unit can determine by majority decision which channel is considered to be faulty.

For example, a difference between the first speed information value and the motor information value can be used to check whether there is a deviation. At the same time, it is possible to check whether the second speed information value has a deviation from the motor information value and whether the first speed information value differs from the second speed information value.

If it is then determined that the first speed information value is different from the motor information value, but the second speed information value is the same as the motor information value and the two speed information values are different from each other, it can be concluded, for example, that the first speed information value is incorrect. The actuator is then not controlled via the first channel, but via the second channel, as the first channel has transmitted the incorrect first speed information value to the selection unit. It is therefore assumed that the first channel is faulty.

Similarly, it can be determined for each of the three values whether it is to be considered to be faulty compared to the other two values to be compared. It is therefore possible to conclude that the first channel is faulty, the second channel is faulty or the motor information unit is faulty.

If it is concluded that a motor information unit is faulty, the selection unit may be designed to give control of the actuator to the channel that already held it.

According to one possible embodiment of the present disclosure, it can be provided that the sensor is provided in a simple design, e.g. simplex, and supplies the speed signal to the first channel and the second channel.

The speed sensor for emitting the speed signal to the first functional unit and the second functional unit is therefore not redundant. The motor information unit, which can also supply a speed information value to the evaluation unit, uses a different starting point on the motor to generate the corresponding information (e.g. by tapping the motor control voltage to obtain a conclusion about the speed of the motor).

According to a further embodiment of the present disclosure, it can be provided that the motor is a DC motor, for example a brushless DC motor.

According to an optional development of the present disclosure, it can be provided that the selection unit is designed to select one of the two channels to control the motor and to utilise the other of the two channels to monitor control of the motor by the first channel.

It may be provided that the first channel and the second channel are each designed to control the motor of the actuator, optionally wherein the first channel and the second channel are identical to each other in their structure. The channel not responsible for controlling the actuator receives the same signalling as the other channel and also processes it as if it were responsible for control, in order to enable the selection unit to check whether the control signals of the active channel supplied to the motor match the control signals (to be rejected) of the inactive channel.

According to one possible embodiment of the present disclosure, it can be provided that the selection unit is not implemented by an FPGA or a microcontroller, but only by logic modules and/or corresponding simple hardware.

This ensures that a rapid response is made to recognise a faulty channel and that control can be switched from one channel to another without having to contact a higher-level computer unit first.

According to a further optional development of the present disclosure, it can be provided that the motor information unit is designed to determine a third speed information value of the motor via a motor voltage, for example a voltage at an output of an output stage of the motor, and/or a motor current.

By forwarding information about the speed of the motor to the selection unit via an alternative path that differs from the speed sensor, a decision can be made as to whether the first channel or the second channel is faulty.

Optionally, it can be provided that the motor information unit is a converter unit for transforming a motor voltage into the third speed information value of the motor.

The following formula can be used for this purpose:

$$n = \frac{V - I \cdot R}{{k}_{e}} ,$$

where n is the speed, V is the applied voltage, I is the current, R is the resistance of the armature winding and kₑ is the electrical constant of the motor.

Assuming a stationary current (and disregarding the inductance of the motor as a result), the following then applies for the voltage:

$$V = I \cdot R + {k}_{e} \cdot n$$

If, however, the inductance L of the windings is also to be taken into account, the change in current over time must also be taken into account, such that the above formula changes as follows:

$$V = I \cdot R + {k}_{e} \cdot n + L \cdot \frac{dI}{dt}$$

It is clear to a person skilled in the art that, for the purposes of the present disclosure, both the simplified formula without taking the current into account and the more complete formula can be used.

Furthermore, according to an optional modification of the present disclosure, it can be provided that the motor information unit is designed to determine a third information value via an open phase winding of the motor, for example of a brushless DC motor.

This represents an alternative or additional way of obtaining a third speed information value, which is fed to the selection unit.

According to a further optional development of the present disclosure, it can be provided that the motor information unit is designed to determine the third information value via an auxiliary winding inserted in the motor.

An auxiliary winding for determining a third speed information value, which is independent of the speed sensor, can also be provided according to the disclosure.

It can also be provided according to the present disclosure that the motor information unit is designed to determine the third speed information value via a further speed sensor attached to the motor.

According to another optional development of the present disclosure, it can be provided that the motor information unit is designed to supply a motor position of the motor to the selection unit, and the selection unit is designed to detect a fault in the speed sensor that sends the speed signal to both the first channel and the second channel on the basis of the motor position obtained.

The motor position is now compared instead of the speed, so that a fault in the sensor shared by the first and second channel and the motor can also be detected.

According to one possible embodiment of the present disclosure, it can be provided that the selection unit is designed to compare the motor information value and the first and second speed information values with one another and, depending on this, to conclude that the first channel or the second channel is faulty and to assign control of the actuator to the channel that is not considered to be faulty, optionally wherein the selection unit is designed to isolate the channel considered to be faulty from the motor.

It is also possible to recognise if the common speed sensor used by both channels emits a faulty signal.

By isolating the channel considered to be faulty from the motor, it is ensured that the faulty channel is not entrusted with controlling the motor, as there is a risk that it will not correctly convert the actuator.

### BRIEF DESCRIPTION OF THE FIGURES

Further features, details and advantages of the disclosure can be seen in the following description of the figures. In the drawings:

The FIGURE shows a schematic representation of an actuator according to the disclosure.

### DETAILED DESCRIPTION

The FIGURE shows a schematic representation of the actuator 1 according to the disclosure with a motor 2 and a speed sensor 4 to detect the speed of the motor. The speed sensor 4 transmits a speed signal to a first functional unit 5 and a second functional unit 7. The first functional unit 5 is part of a first channel 3, which is redundant to a second channel 6 in which the second functional unit 7 is arranged. The first functional unit 5 and the second functional unit 7 may each comprise instructions stored in memory and at least one processor programmed to execute the instructions. When executed, the instructions may cause the processor to receive an input signal from the speed sensor 4, apply a signal processing algorithm to the input signal to generate a processed signal, and output the processed signal. In some examples, the first functional unit 5 and the second functional unit 7 may comprise a microcontroller or an FPGA.

Both the first channel 3 and the second channel 6 have corresponding power electronics 10 to control the motor 2.

The first channel 3 and the second channel 6 are each connected to a selection unit 8, which decides which of the two channels 3, 6 is given control over the actuator 1. The other channel, which does not have control over the actuator, continues to perform the same operations as the channel performing the control and forwards the information thus generated to the selection unit 8. A permanent comparison of the information generated by the first channel 3 and the second channel 6 takes place in the selection unit 8, so that a decision can be made as to whether there is a deviation between the first channel 3 and the second channel 6. If this is the case, the selection unit 8 now knows that one of the two channels is faulty.

In some embodiments, the selection unit 8 may be implemented by the same microcontroller or FPGA as the first functional unit 5 and/or the second functional unit 7. In other embodiments, the selection unit 8 is implemented by a distinct controller. In yet other embodiments, the selection 8 may be implemented by a dedicated comparison logic circuit, or other simple logic modules and/or corresponding hardware. Using dedicated logic circuitry for the selection unit 8 may reduce the computational load on the controller associated with the first functional unit 5 and/or the second functional unit 7, thereby improving response time, and simplifying the overall system design.

In addition, a motor information unit 9 can be recognised, that also provides a speed information value (then the third speed information value in total) to the selection unit 8, for example, based on information derived from the motor 2.

This enables the selection unit 8 not only to be informed of a fault state of one of the two channels 3, 6, but also to identify a channel 3, 6 that is considered to be operating incorrectly by means of a majority decision of the total of three speed information values transmitted to the selection unit 8.

A first fault (fault 1) can be calculated, for example, by determining a difference between the signal (speed L1) of the first channel 3 and the signal (speed U) of the motor information unit 9, whereas a second fault (fault 2) is determined by a difference between the signal (speed L2) of the second channel 6 and the signal (speed U) of the motor information unit 9.

In addition, the selection unit 8 can check whether the first channel and the second channel transmit different signals to the selection unit 8 (see imbalance).

The different cases are summarised in the following table, wherein in the first case the first channel has control via the actuator (in CMD) and in the second case the second channel has control via the actuator. The other channel is in a monitoring state (in MON) and does not supply any control signals to the motor 2.

In order to prevent the supply of signals to the motor 2, corresponding switches S(n/o)1, S(n/o)2 can be provided, which separate the motor electronics from the power electronics 10 of the first channel 3 or the second channel 6.

In the following is a table of the possible cases described above, wherein a fault in the channel in charge of controlling the motor causes control to switch to the other channel previously in the monitoring state. A fault in the channel used for monitoring does not lead to a change, nor does a fault detected in the speed sensor 4.

| | | Fault 1 | Fault 2 | Imbalance | |
|---|---|---|---|---|---|
| | State 1. | Speed L1 − | Speed L2 − | Speed L1 − | State 2. |
| Case | Channel 3 | Speed U | Speed U | Speed L2 | Channel 6 |
| 1st channel 3 fault | IN CMD | Err 1 NOK | Err 2 OK | NOK | IN MON |
| 2nd channel 6 fault | IN CMD | Err 1 OK | Err 2 NOK | NOK | IN MON |
| Motor information | IN CMD | Err 1 NOK | Err 2 NOK | OK | IN MON |
| unit 9 fault | | | | | |
| 1 st channel 3 fault | IN MON | Err 1 OK | Err 2 NOK | NOK | IN CMD |
| 2nd channel 6 fault | IN MON | Err 1 NOK | Err 2 OK | NOK | IN CMD |
| Motor information | IN MON | Err 1 NOK | Err 2 NOK | OK | IN CMD |
| unit 9 fault | | | | | |

The table illustrates various fault scenarios and corresponding system states in the redundant channel actuator system. In a first case (1st channel 3 fault), when the first channel 3 is initially in command mode (IN CMD) and experiences a fault, a discrepancy (NOK) is detected between Speed L1 and Speed U, while Speed L2 and Speed U show agreement (OK). An imbalance (NOK) is detected between Speed L1 and Speed L2. Under these conditions, the second channel 6, which was initially in monitor mode (IN MON), takes over control of the actuator.

In a second case (2nd channel 6 fault), when the first channel 3 is in command mode and the second channel 6 experiences a fault, the system detects agreement (OK) between Speed L1 and Speed U, but identifies a discrepancy (NOK) between Speed L2 and Speed U. An imbalance (NOK) between Speed L1 and Speed L2 is also detected. In this case, the first channel 3 maintains control of the actuator while the second channel 6 remains in monitor mode.

When the motor information unit experiences a fault, both Fault 1 and Fault 2 indicate discrepancies (NOK), but no imbalance (OK) is detected between Speed L1 and Speed L2. In this situation, the commanding channel retains control of the actuator.

The table further demonstrates that these same principles apply when the initial states are reversed, with the second channel 6 starting in command mode (IN CMD) and the first channel 3 in monitor mode (IN MON).

It can be seen that to change the control from the first channel to the second channel or vice versa, two of the three comparisons carried out must indicate that one channel is to be considered to be faulty. Only then is control removed from a channel and transferred to the channel previously used for monitoring. If, on the other hand, it is determined that the channel used for monitoring is faulty, there is of course no change of control. Nor is there a change of control if the comparisons indicate that the speed sensor 4, which supplies the speed signals to the respective channels, is identified as faulty.

Another advantage is that the selection unit can be fully tested by applying an output voltage in an isolated state, which can confirm its functionality.

The disclosure also comprises the possibility of comparing the motor position instead of the motor speed, which also means that motor faults or a fault in the common sensor, which supplies the motor position to both channels, can be recognised. It may be provided that the selection unit is expanded to include a current measurement. In addition, complete sensorless position detection can be used, which further reduces the need for cost-intensive hardware.

The loss of the motor evaluation unit 9 can be signalled to the higher-level system. For this purpose, the functional units 5 and 7 may also have a communication unit that sends the message to the higher-level system.

### LIST OF REFERENCE NUMERALS

1 Actuator
2 Motor
3 First channel
4 Common sensor, e.g. speed sensor
5 Functional unit of the first channel
6 Second channel
7 Functional unit of the second channel
8 Selection unit
9 Motor information unit
10 Power electronics

1. An actuator with redundant channels comprising:
a motor for actuating the actuator,
a sensor for detecting and transmitting a speed signal from the motor,
a first channel, which has a first functional unit connected to the sensor for operating the actuator,
a second channel redundant to the first channel, which has a second functional unit connected to the sensor for operating the actuator,
a selection unit for selecting whether the first channel or the second channel is given control of the actuator, and
a motor information unit for providing a motor information value to the selection unit,
wherein the first channel supplies a first speed information value based on the speed signal to the selection unit and the second channel supplies a second speed information value based on the speed signal to the selection unit, and
wherein the selection unit is designed to make a decision on the basis of the motor information value and the first and second speed information values as to whether the first channel or the second channel is given control of the actuator.

2. The actuator according to claim 1, wherein the first functional unit and the second functional unit are each designed to determine the speed information from the speed signal of the sensor and/or each comprise a communication unit in order to be able to communicate with a higher-level control unit.

3. The actuator according to claim 1, wherein the first speed information value and the second speed information value of the motor is a speed of the motor.

4. The actuator according to claim 1, wherein the motor information value of the motor information unit is a speed of the motor.

5. The actuator according to claim 1, wherein the sensor operates in a simplex mode, and supplies the speed signal to the first channel and the second channel.

6. The actuator according to claim 1, wherein the motor is a DC motor.

7. The actuator according to claim 1, wherein the selection unit is designed to select one of the two channels to control the motor and to utilise the other of the two channels to monitor control of the motor by the first channel.

8. The actuator according to claim 1, wherein the selection unit is not implemented by an FPGA or a microcontroller, but only by logic modules and/or corresponding simple hardware.

9. The actuator according to claim 1, wherein the motor information unit is designed to determine a third speed information value of the motor via a motor voltage and/or a motor current.

10. The actuator according to claim 9, wherein the motor information unit is a converter unit for transforming the motor voltage into the third speed information value of the motor.

11. The actuator according to claim 9, wherein the motor information unit is designed to determine the third speed information value via an open phase winding of the motor.

12. The actuator according to claim 9, wherein the motor information unit is designed to determine the third speed information value via an auxiliary winding inserted in the motor.

13. The actuator according to claim 9, wherein the motor information unit is designed to determine the third speed information value via a further sensor attached to the motor.

14. The actuator according to claim 1, wherein:
the motor information unit is designed to supply a motor position of the motor to the selection unit, and
the selection unit is designed to detect a fault in the sensor that sends the speed signal to both the first channel and the second channel on the basis of the motor position obtained.

15. The actuator according to claim 1, wherein the selection unit is designed to compare the motor information value and the first and second speed information values with one another and, depending on the comparison, to conclude that the first channel or the second channel is faulty and to assign control of the actuator to the channel that is not considered to be faulty.

16. The actuator according to claim 1, wherein the motor information value is a third speed information value of the motor.

17. The actuator according to claim 3, wherein the speed of the motor is a target speed and/or an actual speed of the motor.

18. The actuator according to claim 4, wherein the speed of the motor is a target speed and/or an actual speed of the motor, or a position of the motor.

19. The actuator according to claim 6, wherein the DC motor is a brushless DC motor.

20. The actuator according to claim 9, wherein the motor voltage is a voltage at an output of an output stage of the motor.
